(19) United States
(12) Patent Application Publication
(10) Pub. No.: US 2025/0180866 A1
(43) Pub. Date: Jun. 5, 2025

(54) CAMERA OPTICAL LENS

(71) Applicant: AAC Optics (Suzhou) Co., Ltd., Suzhou (CN)

(72) Inventors: Lili Miao, Suzhou (CN); Shunda Zhou, Suzhou (CN)

(21) Appl. No.: 18/673,321

(22) Filed: May 24, 2024

(30) Foreign Application Priority Data
Dec. 4, 2023 (CN) 202311639762.1

(51) Int. Cl. G02B 9/62; G02B 13/00

(52) U.S. Cl. CPC G02B 9/62; G02B 13/0045

(57) ABSTRACT

The present application relates to the field of optical lenses and discloses a camera optical lens including, in order from an objective surface to an image surface: a first lens having a negative refractive force, a second lens having a refractive force, a third lens having a negative refractive force, a fourth lens having a positive refractive force, a fifth lens having a positive refractive force, and a sixth lens having a negative refractive force; a refractive index of the first lens is n1; a focal length of the camera optical lens is f; an optical total length of the camera optical lens is TTL; a central radius of curvature of an objective surface of the sixth lens of R11; a central radius of curvature of an image surface of the sixth lens of R12, and the following relationship expressions are satisfied: n1≥1.70; 5.00≤TTL/f≤6.50; −6.70≤R12/R11≤−1.80.

### CROSS-REFERENCE TO RELATED APPLICATIONS

This application claims the priority of Chinese Patent Application No. 202311639762.1, entitled “CAMERA OPTICAL LENS”, filed with the China National Intellectual Property Administration on Dec. 4, 2023, which is incorporated herein by reference in its entirety.

### TECHNICAL FIELD

The present application relates to the field of optical lenses, in particular to a camera optical lens applicable to handheld terminal devices such as smartphones and digital cameras, as well as camera devices such as monitors, PC lenses, in-vehicle lenses, and drones.

### BACKGROUND

In recent years, with the rise of various smart devices, the demand for miniaturized camera optical lenses has been increasing. Additionally, due to the reduction in pixel size of photosensitive devices and the current trend of electronic products towards better functionality and lighter, more portable designs, miniaturized camera optical lenses with good imaging quality have become the mainstream in the market. To achieve better imaging quality, multi-element lens structures are often employed. Furthermore, with the advancement of technology and the increasing diversity of user demands, coupled with the continuous reduction in pixel area of photosensitive devices and the escalating requirements for imaging quality, six-element lens structure has gradually emerged in lens design. There is an urgent need for camera optical lenses with excellent optical performance, large aperture, and ultra-wide-angle capabilities.

### SUMMARY

In response to the above problem, an object of the present application is to provide a camera optical lens that has good optical performance while meeting the design requirements of large aperture and ultra-wide angle.

In order to solve the above technical problems, an embodiment of the present application provides a camera optical lens, the camera optical lens comprising, in order from an objective side to an image side: a first lens having a negative refractive force, a second lens having a refractive force, a third lens having a negative refractive force, a fourth lens having a positive refractive force, a fifth lens having a positive refractive force, and a sixth lens having a negative refractive force; the first lens being made of glass; the fourth lens is made of glass; wherein a refractive index of the first lens is n1; a focal length of the camera optical lens is f, an optical total length of the camera optical lens is TTL; a central radius of curvature of an objective surface of the sixth lens of R11; a central radius of curvature of an image surface of the sixth lens of R12, and the following relationship expressions are satisfied: n1≥1.70; 5.00≤TTL/f≤6.50; −6.70≤R12/R11≤−1.80.

In one embodiment, an Abbe number of the fourth lens is v4, and the following relationship expression is satisfied: 60.00≤v4≤91.00.

In one embodiment, an on-axis thickness of the second lens is d3; an on-axis thickness of the third lens is d5, and the following relationship expression is satisfied: 1.68≤d5/d3≤6.00.

In one embodiment, a focal length of the fifth lens is f5, and the following relationship expression is satisfied: 1.00≤f5/f≤2.10.

In one embodiment, an on-axis distance from an image surface to an image surface of the sixth lens is BF, and the following relationship expression is satisfied: 0.20≤BF/TTL≤0.35.

In one embodiment, an objective surface of the first lens is convex at a proximal-axis position, and an image surface of the first lens is concave at a proximal-axis position; a focal length of the first lens is f1; a central radius of curvature of the objective surface of the first lens is R1; a central radius of curvature of the image surface of the first lens is R2; an on-axis thickness of the first lens is d1, and the following relationship expressions are satisfied: −3.89≤f1/f≤−1.01; 0.82≤(R1+R2)/(R1−R2)≤3.22; 0.02≤d1/TTL≤0.34.

In one embodiment, an objective surface of the second lens is concave at a proximal-axis position, and an image surface of the second lens is convex at a proximal-axis position; a focal length of the second lens is f2; a central radius of curvature of the objective surface of the second lens is R3; a central radius of curvature of the image surface of the second lens is R4; an on-axis thickness of the second lens is d3, and the following relationship expressions are satisfied: −95.3≤f2/f≤37.04; −25.35≤(R3+R4)/(R3−R4)≤34.72; 0.01≤d3/TTL≤0.13.

In one embodiment, an objective surface of the third lens is concave at a proximal-axis position, and an image surface of the third lens is convex at a proximal-axis position; a focal length of the third lens is f3; a central radius of curvature of the objective surface of the third lens is R5; a central radius of curvature of the image surface of the third lens is R6; an on-axis thickness of the third lens is d5, and the following relationship expressions are satisfied: −1980≤f3/f≤−8.53; −16.53≤(R5+R6)/(R5−R6)≤−3.57; 0.07≤d5/TTL≤0.28.

In one embodiment, an objective surface of the fourth lens is convex at a proximal-axis position; an image surface of the fourth lens is convex at a proximal-axis position; a focal length of the fourth lens is f4; a central radius of curvature of the objective surface of the fourth lens is R7; a central radius of curvature of the image surface of the fourth lens is R8; an on-axis thickness of the fourth lens is d7, and the following relationship expressions are satisfied: 0.78≤f4/f≤3.29; −0.65≤(R7+R8)/(R7−R8)≤0.06; 0.03≤d7/TTL≤0.22.

In one embodiment, the first lens is made of glass, and the fourth lens is made of glass.

The beneficial effect of the present application is that the camera optical lens according to the present application has excellent optical characteristics and has a large aperture and an ultra-wide angle, and is particularly suitable for smartphone camera lens assemblies including camera elements such as CCD, CMOS, and the like used for high pixel counts, WEB camera lenses, and day-night confocal vehicle lenses with the working waveband in RGB+IR.

### BRIEF DESCRIPTION OF THE DRAWINGS

In order to more clearly illustrate the technical solutions in the embodiments of the present application, the accompanying drawings that need to be used in the description of the embodiments will be briefly introduced as follows. Obviously, the accompanying drawings in the following description are only some of the embodiments of the present application, and for the person of ordinary skill in the field, other accompanying drawings can be obtained based on these drawings without putting forth any creative labor.

FIG. 1 is a structural schematic diagram of a camera optical lens according to the first embodiment of the present application.

FIG. 2 is a schematic diagram of the axial aberration of the camera optical lens shown in FIG. 1.

FIG. 3 is a schematic diagram of the magnification chromatic aberration of the camera optical lens shown in FIG. 1.

FIG. 4 is a schematic diagram of the field curvature and distortion of the camera optical lens shown in FIG. 1.

FIG. 5 is a structural schematic diagram of the camera optical lens according to the second embodiment of the present application.

FIG. 6 is a schematic diagram of the axial aberration of the camera optical lens shown in FIG. 5.

FIG. 7 is a schematic diagram of the magnification chromatic aberration of the camera optical lens shown in FIG. 5.

FIG. 8 is a schematic diagram of field curvature and distortion of the camera optical lens shown in FIG. 5.

FIG. 9 is a structural schematic diagram of the camera optical lens according to the third embodiment of the present application.

FIG. 10 is a schematic diagram of the axial aberration of the camera optical lens shown in FIG. 9.

FIG. 11 is a schematic diagram of the magnification chromatic aberration of the camera optical lens shown in FIG. 9.

FIG. 12 is a schematic diagram of field curvature and distortion of the camera optical lens shown in FIG. 9.

FIG. 13 is a structural schematic diagram of the camera optical lens according to the fourth embodiment of the present application.

FIG. 14 is a schematic diagram of the axial aberration of the camera optical lens shown in FIG. 13.

FIG. 15 is a schematic diagram of the magnification chromatic aberration of the camera optical lens shown in FIG. 13.

FIG. 16 is a schematic diagram of field curvature and distortion of the camera optical lens shown in FIG. 13.

FIG. 17 is a structural schematic diagram of the camera optical lens according to the fifth embodiment of the present application.

FIG. 18 is a schematic diagram of the axial aberration of the camera optical lens shown in FIG. 17.

FIG. 19 is a schematic diagram of the magnification chromatic aberration of the camera optical lens shown in FIG. 17.

FIG. 20 is a schematic diagram of field curvature and distortion of the camera optical lens shown in FIG. 17.

FIG. 21 is a structural schematic diagram of a camera optical lens according to the sixth embodiment of the present application.

FIG. 22 is a schematic diagram of the axial aberration of the camera optical lens shown in FIG. 21.

FIG. 23 is a schematic diagram of the magnification chromatic aberration of the camera optical lens shown in FIG. 21.

FIG. 24 is a schematic diagram of field curvature and distortion of the camera optical lens shown in FIG. 21.

FIG. 25 is a schematic diagram of the structure of the camera optical lens of the comparison embodiment.

FIG. 26 is a schematic diagram of the axial aberration of the camera optical lens shown in FIG. 25.

FIG. 27 is a schematic diagram of the magnification chromatic aberration of the camera optical lens shown in FIG. 25.

FIG. 28 is a schematic diagram of the field curvature and distortion of the camera optical lens shown in FIG. 25.

### DETAILED DESCRIPTION OF THE EMBODIMENTS

In order to make the objects, technical solutions, and advantages of the present application clearer, various embodiments of the present application will be described in detail below in connection with the accompanying drawings. However, those of ordinary skill in the art can understand that in the various embodiments of the present application, a number of technical details have been proposed in order to enable the reader to better understand the present application, and even without these technical details and various variations and modifications based on the following various embodiments, the technical solution claimed to be protected by the present application can be realized.

### First Embodiment

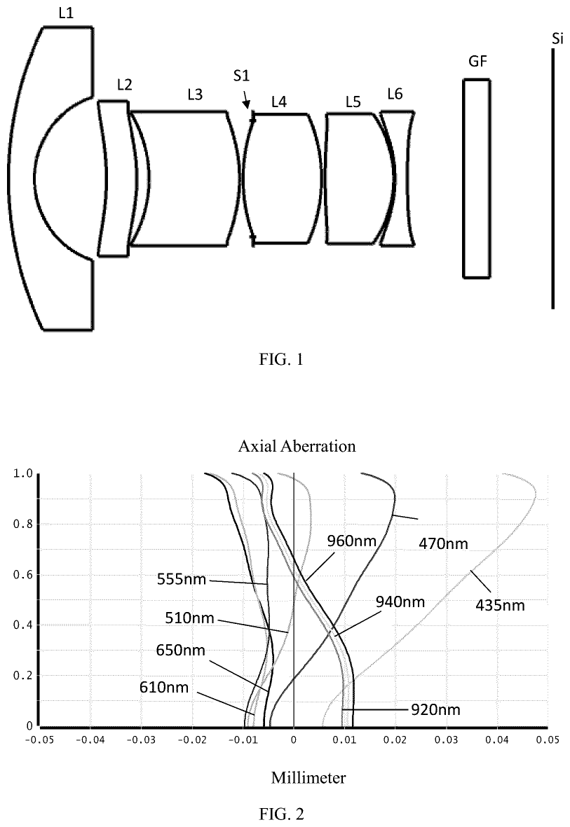

As shown in the accompanying drawings, the present application provides a camera optical lens 10. FIG. 1 shows a structural schematic diagram of a camera optical lens 10 according to the first embodiment of the present application. The camera optical lens 10 includes a total of six lenses. Specifically, the camera optical lens 10, in order from an objective side to an image side, includes a first lens L1, a second lens L2, a third lens L3, a fourth lens L4, an aperture Si, a fifth lens L5, and a sixth lens L6. An optical element such as an optical filter GF may be provided between the sixth lens L6 and the image surface Si.

In this embodiment, the first lens L1 is made of glass, the second lens L2 is made of plastic, the third lens L3 is made of plastic, the fourth lens L4 is made of glass, the fifth lens L5 is made of plastic, and the sixth lens L6 is made of plastic. In other embodiments, the respective lenses may also be made of other materials.

In this embodiment, it is defined that a refractive index of the first lens L1 is n1, and the following relationship expression is satisfied: n1≥1.70, in which the refractive index of the first lens specified, and the first lens is prioritized to be made of a high refractive index material. Within the range of the relationship expression, it is conducive to the front-end aperture reduction and the improvement of the imaging quality.

In this embodiment, it is defined that a focal length of the camera optical lens 10 is f, a total optical length of the camera optical lens 10 is TTL, and the following relationship expression is satisfied: 5.00≤TTL/f≤6.50, in which a ratio of the total length of the prescribed system to the focal length is specified. Within the range of the relationship expression, it is possible to control the total optical length to become shorter, which is easy to realize miniaturization; besides, it is possible to effectively balance the amount of the field curvature of the system, so that a field curvature offset of a central field of view is less than 0.02 mm.

In this embodiment, it is defined that a central radius of curvature of an objective surface of the sixth lens L6 is R11, a central radius of curvature of an image surface of the sixth lens L6 is R12, and the following relationship expression is satisfied: −6.70≤R12/R11≤−1.80, in which the shape of the sixth lens is specified. Within the range of the relationship expression, it can moderate the degree of deflection of the light passing through the lens, so as to enable the system to have a better imaging quality and a lower sensitivity. low sensitivity.

In this embodiment, it is defined that the Abbe number of the fourth lens L4 is v4, and the following relationship expression is satisfied: 60.00≤v4≤91.00, in which the Abbe number of the fourth lens L4 is specified. Within the range of the relationship expression, it can effectively assign the material properties, effectively improve the aberration, and enhance the imaging quality.

In this embodiment, it is defined that an on-axis thickness of the second lens L2 is d3, an on-axis thickness of the third lens L3 is d5, and the following relationship expression is satisfied: 1.68≤d5/d3≤6.00, in which a ratio of the center thickness of the third lens to the center thickness of the second lens is specified. Within the range of the relationship expression, by reasonably allocating the center thickness between the lenses, it is conducive to reducing the difficulty of assembling the lenses in the actual production process and improving the yield rate.

In this embodiment, it is defined that the focal length of the camera optical lens 10 is f, a focal length of the fifth lens L5 is f5, and the following relationship expression is satisfied: 1.00≤5/f≤2.10. Within the range of the relationship expression, the value of the focal length of the fifth lens is controlled, and the focal length is reasonably allocated, which is conducive to controlling the temperature flutter and improving the temperature performance.

In this embodiment, it is defined that an on-axis distance from the image surface of the sixth lens L6 to the image surface Si is BF, and the following relationship expression is satisfied: 0.20≤BF/TTL≤0.35. Within the range of the relationship expression, the back focal length is long, which is conducive to the assembly of the module on the basis of realizing miniaturization.

In this embodiment, the objective surface of the first lens L1 is convex in a proximal-axis position, an image surface is concave in a proximal-axis position, and the first lens L1 has a negative refractive force. In other embodiments, the objective surface and image surface of the first lens L1 may also be set to other concave and convex distributions.

It is defined that the focal length of the camera optical lens 10 is f, a focal length of the first lens L1 is f1, and the following relationship expression is satisfied: −3.89≤f1/f≤−1.01, in which a ratio of the negative refractive force of the first lens L1 to the overall focal length is specified. Within the range of the relationship expression, the first lens has an appropriate negative refractive force, which is conducive to reducing system aberration, and is also conducive to the lens being developed towards ultra-thinness and wide angle. In some embodiments, −2.43≤f1/f≤−1.26 is satisfied.

It is defined that a central radius of curvature of the objective surface of the first lens L1 is R1, a central radius of curvature of the image surface of the first lens L1 is R2, and the following relationship expression is satisfied: 0.82≤(R1+R2)/(R1−R2)≤3.22, in which the shape of the first lens L1 is reasonably controlled, so that the first lens L1 is able to efficiently correct the system spherical aberration. In some embodiments, 1.32≤(R1+R2)/(R1−R2)≤2.58 is satisfied.

An on-axis thickness of the first lens L1 is d1, a total optical length of the camera optical lens 10 is TTL, and the following relationship expression is satisfied: 0.02≤d1/TTL≤0.34. Within the range of the relationship expression, it is conducive to miniaturization. In some embodiments, 0.03≤d1/TTL≤0.27 is satisfied.

In this embodiment, an objective surface of the second lens L2 is concave at a proximal-axis position, an image surface is convex at a proximal-axis position, and the second lens L2 has a positive refractive force or a negative refractive force. In other embodiments, the objective surface and image surface of the second lens L2 may also be set to other concave and convex distributions.

It is defined that the focal length of the camera optical lens 10 is f, a focal length of the second lens L2 is f2, and the following relationship expression is satisfied: −95.3≤f2/f≤37.04, which is conducive to correcting the aberration of the optical system by controlling the negative optical focus of the second lens L2 in a reasonable range. In some embodiments, −59.6≤f2/f≤29.63 is satisfied.

A central radius of curvature of the objective surface of the second lens L2 is R3, a central radius of curvature of the image surface of the second lens L2 is R4, and the following relationship expression is satisfied: −25.35≤(R3+R4)/(R3−R4)≤34.72, in which the shape of the second lens L2 is specified. Within the range, it is conducive to correcting the aberration of the off-axis drawing angle and other problems with the development of the ultra-thinness and wide angle. In some embodiments, −15.84≤(R3+R4)/(R3−R4)≤27.78 is satisfied.

An on-axis thickness of the second lens L2 is d3, the optical total length of the camera optical lens 10 is TTL, and the following relationship expression is satisfied: 0.01≤d3/TTL≤0.13. Within the range of the relationship expression, it is favorable for miniaturization. In some embodiments, 0.02≤d3/TTL≤0.11 is satisfied.

In this embodiment, an objective surface of the third lens L3 is concave at a proximal-axis position, an image surface of the third lens L3 is convex at a proximal-axis position, and the third lens L3 has a negative refractive force. In other embodiments, the objective surface and image surface of the third lens L3 may also be set to other concave and convex distributions.

It is defined that the focal length of the camera optical lens 10 is f, a focal length of the third lens L3 is f3, and the following relationship expression is satisfied: −1980≤f3/f≤−8.53, in which the system is made to have better imaging quality and lower sensitivity through the reasonable distribution of optical focal length. In some embodiments, −1240≤f3/f≤−10.7 is satisfied.

A central radius of curvature of the objective surface of the third lens L3 is R5, a central radius of curvature of the image surface of the third lens L3 is R6, and the following relationship expression is satisfied: −16.53≤(R5+R6)/(R5−R6)≤−3.57. Within the range of the relationship expression, the shape of the third lens L3 can be effectively controlled, which is conducive to the molding of the third lens L3, and avoiding poor molding and low sensitivity due to the surface curvature of the third lens L3 being too large. In some embodiments, −10.33≤(R5+R6)/(R5−R6)≤−4.46 is satisfied.

An on-axis thickness of the third lens L3 is d5, the optical total length of the camera optical lens 10 is TTL, and the following relationship expression is satisfied: 0.07≤d5/TTL≤0.28. Within the range of the relationship expression, and is favorable for miniaturization. In some embodiments, 0.11≤d5/TTL≤0.22 is satisfied.

In this embodiment, an objective surface of the fourth lens L4 is convex at a proximal-axis position, an image surface is convex at a proximal-axis position, and the fourth lens L4 has a positive refractive force. In other embodiments, the objective surface and image surface of the fourth lens L4 may also be set to other concave and convex distributions.

It is defined that the focal length of the camera optical lens 10 is f, a focal length of the fourth lens L4 is f4, and the following relationship expression is satisfied: 0.78≤f4/f≤3.29, the system is made to have better imaging quality and lower sensitivity through the reasonable distribution of optical focal length. In some embodiments, 1.25≤f4/f≤2.64 is satisfied.

A central radius of curvature of the objective surface of the fourth lens L4 is R7, a central radius of curvature of the image surface of the fourth lens L4 is R8, and the following relationship expression is satisfied: −0.65≤(R7+R8)/(R7−R8)≤0.06, in which the shape of the fourth lens L4 is specified. Within the range, it is conducive to correcting the aberration of the off-axis drawing angle and other problems with the development of the ultra-thinness and wide angle. In some embodiments, −0.41≤(R7+R8)/(R7−R8)≤0.05 is satisfied.

An on-axis thickness of the fourth lens L4 is d7, the optical total length of the camera optical lens 10 is TTL, and the following relationship expression is satisfied: 0.03≤d7/TTL≤0.22. Within the range of the relationship expression, it is favorable for miniaturization. In some embodiments, 0.05≤d7/TTL≤0.17 is satisfied.

In this embodiment, an objective surface of the fifth lens L5 is convex at a proximal-axis position, an image surface is convex at a proximal-axis position, and the fifth lens L5 has a positive refractive force. In other embodiments, the objective surface and image surface of the fifth lens L5 may also be set to other concave and convex distributions.

It is defined that a central radius of curvature of the objective surface of the fifth lens L5 is R9, a central radius of curvature of the image surface of the fifth lens L5 is R10, and the following relationship expression is satisfied: 0.31≤(R9+R10)/(R9−R10)≤1.11, in which the shape of the fifth lens L5 is specified. Within the range, it is conducive to correcting the aberration of the off-axis drawing angle and other problems with the development of the ultra-thinness and wide angle. In some embodiments, 0.50≤(R9+R10)/(R9−R10)≤0.89 is satisfied.

It is defined that an on-axis thickness of the fifth lens L5 is d9, the optical total length of the camera optical lens 10 is TTL, and the following relationship expression is satisfied: 0.05≤d9/TTL≤0.21. Within the range of the relationship expression, it is favorable for miniaturization. In some embodiments, 0.07≤d9/TTL≤0.17 is satisfied.

In this embodiment, an objective surface of the sixth lens L6 is concave at a proximal-axis position, an image surface is concave at a proximal-axis position, and the sixth lens L6 has a negative refractive force. In other embodiments, the objective surface and the image surface of the sixth lens L6 may also be provided with other concave and convex distributions.

The focal length of the camera optical lens 10 is f, and a focal length of the sixth lens L6 is f6, and the following relationship expression is satisfied: −4.10≤f6/f≤−0.69, in which the system is made to have better imaging quality and lower sensitivity through the reasonable distribution of the optical focal length. In some embodiments, −2.56≤f6/f≤−0.87 is satisfied.

A central radius of curvature of the objective surface of the sixth lens L6 is R11, a central radius of curvature of the image surface of the sixth lens L6 is R12, and the following relationship expression is satisfied: −1.48≤(R11+R12)/(R11−R12)≤−0.19, in which the shape of the sixth lens L6 is specified. Within the range, it is conducive to correcting the aberration of the off-axis drawing angle and other problems with the development of the ultra-thinness and wide angle. In some embodiments, −0.92≤(R11+R12)/(R11−R12)≤−0.24 is satisfied.

An on-axis thickness of the sixth lens L6 is d11, the optical total length of the camera optical lens 10 has TTL, and the following relationship expression is satisfied: 0.00≤d11/TTL≤0.03. Within the range of the relationship expression, it is conducive to miniaturization. In some embodiments, 0.01≤d11/TTL≤0.03 is satisfied.

In this embodiment, an aperture value FNO of the camera optical lens 10 is less than or equal to 2.0, thereby realizing a large aperture and good imaging performance of the camera optical lens.

In this embodiment, a field of view (FOV) of the camera optical lens 10 is greater than or equal to 125°, thereby realizing an ultra-wide angle and good imaging performance of the camera optical lens.

The camera optical lens 10 has good optical performance while being able to meet the design requirements of large aperture and ultra-wide angle. According to the characteristics of the camera optical lens 10, the camera optical lens 10 is particularly suitable for smartphone camera lens assemblies including camera elements such as CCDs, CMOS and the like for high pixel counts, WEB camera lenses, and day-night confocal vehicle lenses with the working waveband in RGB+IR.

The camera optical lens 10 of the present application will be described below by way of examples, and the symbols recorded in each example are shown below. The units of focal length, on-axis distance, central radius of curvature, on-axis thickness, inflection point position, and stationary point position are mm.

TTL: The total optical length (the on-axis distance from the objective surface of the first lens L1 to the image surface Si) in mm;

Aperture value FNO: a ratio of the effective focal length of the camera optical lens to the diameter of the Entrance Pupil Diameter (ENPD).

In some embodiments, the lens may also be provided with inflection points and/or stationary points on the objective surface and/or the image surface, to satisfy the requirement for high-quality imaging, as described below for specific implementable embodiments.

Tables 1 and 2 show the design data of the camera optical lens 10 of the first embodiment of the present application.

TABLE 1

| | R | d | | nd | | νd | |
|---|---|---|---|---|---|---|---|
| S1 | ∞ | d0= | −6.603 | | | | |
| R1 | 9.006 | d1= | 0.700 | nd1 | 1.8160 | ν1 | 46.56 |
| R2 | 2.258 | d2= | 1.945 | | | | |
| R3 | −6.370 | d3= | 0.822 | nd2 | 1.6613 | ν2 | 20.37 |
| R4 | −4.529 | d4= | 0.334 | | | | |
| R5 | −2.984 | d5= | 2.439 | nd3 | 1.5370 | ν3 | 55.98 |
| R6 | −3.855 | d6= | 0.100 | | | | |
| R7 | 4.378 | d7= | 2.115 | nd4 | 1.4565 | ν4 | 90.27 |
| R8 | −4.063 | d8= | 0.100 | | | | |
| R9 | 15.680 | d9= | 1.853 | nd5 | 1.5370 | ν5 | 55.98 |
| R10 | −2.896 | d10= | 0.030 | | | | |
| R11 | −3.799 | d11= | 0.338 | nd6 | 1.6613 | ν6 | 20.37 |
| R12 | 17.506 | d12= | 1.518 | | | | |
| R13 | ∞ | d13= | 0.700 | ndg | 1.5168 | νg | 64.17 |
| R14 | ∞ | d14= | 1.718 | | | | |

The meaning of each symbol is as follows.
Si: aperture;
R: central radius of curvature of the optical surface;
R1: central radius of curvature of the objective surface of the first lens L1;
R2: central radius of curvature of the image surface of the first lens L1;
R3: central radius of curvature of the objective surface of the second lens L2;
R4: central radius of curvature of the image surface of the second lens L2;
R5: central radius of curvature of the objective surface of the third lens L3;
R6: central radius of curvature of the image surface of the third lens L3;
R7: central radius of curvature of the objective surface of the fourth lens L4;
R8: central radius of curvature of the image surface of the fourth lens L4;
R9: central radius of curvature of the objective surface of the fifth lens L5;
R10: central radius of curvature of the image surface of the fifth lens L5;
R11: central radius of curvature of the objective surface of the sixth lens L6;
R12: central radius of curvature of the image surface of the sixth lens L6;
R13: central radius of curvature of the objective surface of the optical filter GF;
R14: central radius of curvature of the image surface of the optical filter GF;
d: on-axis thickness of the lens, on-axis distance between the lenses;
d0: the on-axis distance from the aperture Si to the objective surface of the first lens L1;
d1: on-axis thickness of the first lens L1;
d2: on-axis distance from the image surface of the first lens L1 to the objective surface of the second lens L2;
d3: on-axis thickness of the second lens L2;
d4: on-axis distance from the image surface of the second lens L2 to the objective surface of the third lens L3;
d5: on-axis thickness of the third lens L3;
d6: on-axis distance from the image surface of the third lens L3 to the objective surface of the fourth lens L4;
d7: on-axis thickness of the fourth lens L4;
d8: on-axis distance from the image surface of the fourth lens L4 to the objective surface of the fifth lens L5;
d9: on-axis thickness of the fifth lens L5;
d10: on-axis distance from the image surface of the fifth lens L5 to the objective surface of the sixth lens L6;
d11: on-axis thickness of the sixth lens L6;
d12: on-axis distance from the image surface of the sixth lens L6 to the objective surface of the optical filter GF;
d13: on-axis thickness of the optical filter GF;
d14: on-axis distance from the image surface of the optical filter GF to the image surface Si;
BF: on-axis distance from the image surface of the sixth lens L6 to the image surface Si;
nd: refractive index of the line d (the line d is green light with a wavelength of 550 nm);
nd1: refractive index of the line d of the first lens L1;
nd2: refractive index of the line d of the second lens L2;
nd3: refractive index of the line d of the third lens L3;
nd4: refractive index of the line d of the fourth lens L4;
nd5: refractive index of the line d of the fifth lens L5;
nd6: refractive index of the line d of the sixth lens L6;
ndg: refractive index of the line d of the optical filter GF;
vd: Abbe number;
v1: Abbe number of the first lens L1;
v2: Abbe number of the second lens L2;
v3: Abbe number of the third lens L3;
v4: Abbe number of the fourth lens L4;
v5: Abbe number of the fifth lens L5;
v6: Abbe number of the sixth lens L6;
vg: Abbe number of the optical filter GF.

Table 2 illustrates the aspherical surface data of each lens in the camera optical lens 10 according to the first embodiment of the present application.

TABLE 2

| | Cone Coefficient | Asphericity Coefficient | | | | |
|---|---|---|---|---|---|---|
| | k | A4 | A6 | A8 | A10 | A12 |
| R3 | −5.11798E+00 | 1.49060E−03 | 1.27640E−03 | −1.37630E−03 | 1.20390E−03 | −6.42840E−04 |
| R4 | −4.67235E+00 | 7.95100E−03 | −2.35080E−03 | 2.73010E−03 | −3.66330E−03 | 3.46110E−03 |
| R5 | 6.70105E−01 | 1.64940E−02 | −6.02150E−03 | 3.98080E−03 | −1.73080E−03 | 3.01100E−04 |
| R6 | −1.83270E+01 | −3.41350E−02 | 1.96460E−02 | −1.09130E−02 | 4.89290E−03 | −1.47900E−03 |
| R9 | −3.55801E+01 | 2.64970E−03 | −3.73170E−03 | 5.64880E−03 | −9.43950E−03 | 8.73740E−03 |
| R10 | −7.95284E+00 | −8.12100E−02 | 1.18590E−01 | −1.56910E−01 | 1.38180E−01 | −7.96560E−02 |
| R11 | −1.89259E−01 | −5.36480E−02 | 1.09310E−01 | −1.43440E−01 | 1.25650E−01 | −7.19310E−02 |
| R12 | 7.16650E+01 | −9.94390E−03 | 1.71050E−02 | −9.71840E−03 | 3.22070E−03 | 2.52450E−04 |

| | Cone Coefficient | Asphericity Coefficient | | | |
|---|---|---|---|---|---|
| | k | A14 | A16 | A18 | A20 |
| R3 | −5.11798E+00 | 2.19910E−04 | −4.62400E−05 | 5.41370E−06 | −2.67670E−07 |
| R4 | −4.67235E+00 | −1.96630E−03 | 6.55910E−04 | −1.18740E−04 | 9.03310E−06 |
| R5 | 6.70105E−01 | 1.45560E−04 | −9.76310E−05 | 2.16040E−05 | −1.68640E−06 |
| R6 | −1.83270E+01 | 2.31400E−04 | 6.35050E−06 | −8.37490E−06 | 9.21040E−07 |
| R9 | −3.55801E+01 | −4.89780E−03 | 1.62510E−03 | −2.94130E−04 | 2.24140E−05 |
| R10 | −7.95284E+00 | 2.98100E−02 | −6.98650E−03 | 9.32180E−04 | −5.40480E−05 |
| R11 | −1.89259E−01 | 2.67120E−02 | −6.20590E−03 | 8.20160E−04 | −4.70770E−05 |
| R12 | 7.16650E+01 | −7.51700E−04 | 3.11420E−04 | −5.75690E−05 | 4.14860E−06 |

For convenience, the asphericity surfaces of the individual lens surfaces use the asphericity surfaces shown in Equation (1) below. However, the present application is not limited to the polynomial form of the asphericity surfaces expressed in Equation (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 1 )$$

k is the conic coefficient, A4, A6, A8, A10, A12, A14, A16, A18, A20 are asphericity coefficients; c is a central curvature of the optical surface; r is a perpendicular distance between a point on the aspheric curve and the optical axis, and z is the depth of the asphere (the perpendicular distance between a point on the aspheric surface at a distance of r from the optical axis and the tangent plane tangent to the apex of the aspheric surface on the optical axis).

Tables 3 and 4 show the design data of the inflection point and the stationary point of each lens in the camera optical lens 10 according to the first embodiment of the present application. P1R1, P1R2 represent the objective side and image side of the first lens L1, respectively. P2R1, P2R2 represent the objective side and image side of the second lens L2, respectively. P3R1, P3R2 represent the objective side and image side of the third lens L3, respectively. P4R1, P4R2 represent the objective side and image side of the fourth lens L4, respectively. P5R1, P5R2 represent the objective side and image side of the fifth lens L5, respectively. P6R1, P6R2 represent the objective side and image side of the sixth lens L6, respectively. The data corresponding to the “Position of Inflection Point” field is the perpendicular distance from the inflection point set on the surface of each lens to the optical axis of the camera optical lens 10. The corresponding data in the “Position of the stationary point” field is the perpendicular distance from the stationary point set on the surface of each lens to the optical axis of the camera optical lens 10.

TABLE 3

| | Number of Inflection Points | Position of Inflection Point 1 |
|---|---|---|
| P2R1 | 1 | 1.465 |
| P2R2 | 1 | 1.335 |
| P5R1 | 1 | 1.035 |
| P6R1 | 1 | 1.485 |

TABLE 4

| | Number of Stationary Points | Position of Stationary Point 1 |
|---|---|---|
| P5R1 | 1 | 1.445 |

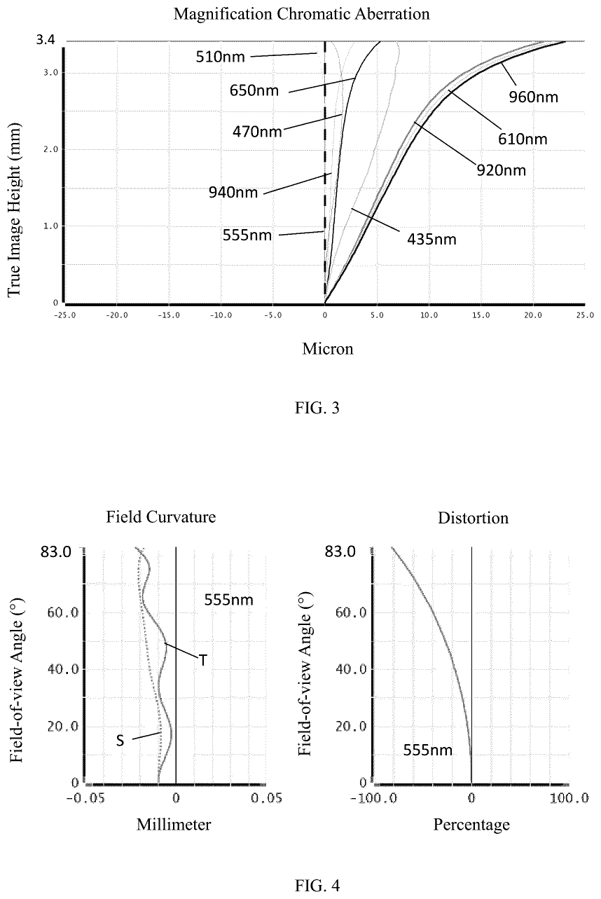

FIGS. 2 and 3 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 10 of the first embodiment. FIG. 4 is a schematic diagram showing the field curvature and distortion of light with a wavelength of 555 nm after passing through the camera optical lens 10 of the first embodiment. The field curvature S of FIG. 4 is a field curvature in the arc-sagittal direction, and T is a field curvature in the meridional direction.

Table 29, which appears later, shows the values corresponding to various values in each embodiment with respect to the parameters that have been specified in the relationship expressions.

As shown in Table 29, the first embodiment satisfies each of the relationship expressions.

In this embodiment, the camera optical lens 10 has an Entrance Pupil Diameter (ENPD) of 1.163 mm, a full field of view image height (IH) of 3.400 mm, and a field-of-view angle (FOV) of 165.96° in the diagonal direction. The camera optical lens 10 satisfies the design requirements of a large aperture and an ultra-wide angle and has excellent optical characteristics due to its on-axis and off-axis chromatic aberrations being sufficiently compensated.

### Second Embodiment

The second embodiment is basically the same as the first embodiment, the meaning of the symbols is the same as that of the first embodiment, and only the differences are listed below.

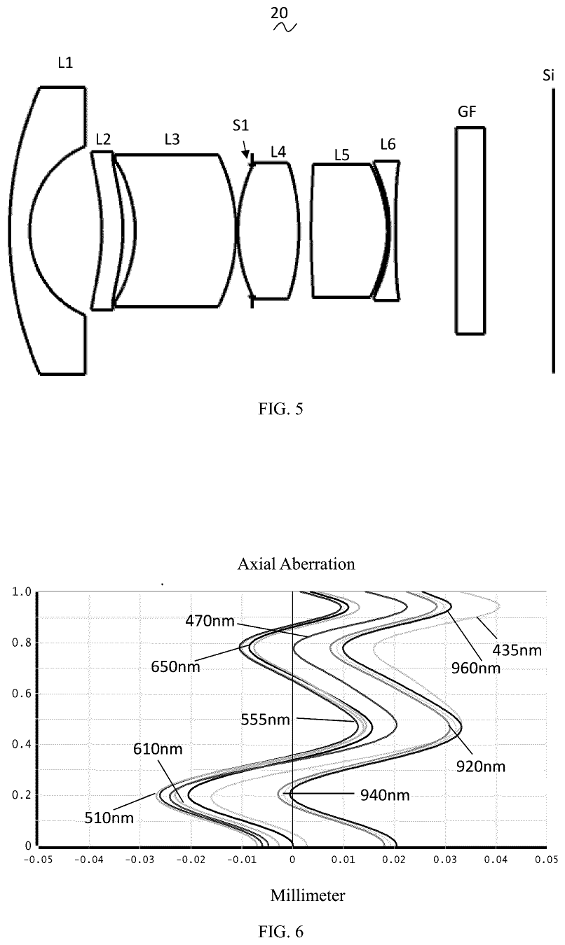

FIG. 5 shows a structural schematic diagram of the camera optical lens 20 of the second embodiment of the present application.

Tables 5 and 6 show the design data of the camera optical lens 20 of the second embodiment of the present application.

TABLE 5

| | R | d | | nd | | νd | |
|---|---|---|---|---|---|---|---|
| S1 | ∞ | d0= | −6.033 | | | | |
| R1 | 8.370 | d1= | 0.499 | nd1 | 1.7015 | ν1 | 41.14 |
| R2 | 2.209 | d2= | 1.794 | | | | |
| R3 | −5.611 | d3= | 0.525 | nd2 | 1.6613 | ν2 | 20.37 |
| R4 | −4.058 | d4= | 0.305 | | | | |
| R5 | −2.964 | d5= | 2.510 | nd3 | 1.5370 | ν3 | 55.98 |
| R6 | −3.921 | d6= | 0.049 | | | | |
| R7 | 3.629 | d7= | 1.516 | nd4 | 1.4565 | ν4 | 90.27 |
| R8 | −5.169 | d8= | 0.300 | | | | |
| R9 | 17.129 | d9= | 1.894 | nd5 | 1.5370 | ν5 | 55.98 |
| R10 | −2.944 | d10= | 0.060 | | | | |
| R11 | −3.585 | d11= | 0.148 | nd6 | 1.6613 | ν6 | 20.37 |
| R12 | 23.837 | d12= | 1.514 | | | | |
| R13 | ∞ | d13= | 0.700 | ndg | 1.5168 | νg | 64.17 |
| R14 | ∞ | d14= | 1.716 | | | | |

Table 6 illustrates aspherical data for each lens in the camera optical lens 20 according to the second embodiment of the present application.

TABLE 6

| | Cone | | | | | |
|---|---|---|---|---|---|---|
| | Coefficient | Asphericity Coefficient | | | | |
| | k | A4 | A6 | A8 | A10 | A12 |
| R3 | −3.60654E+00 | 3.11250E−03 | −9.45870E−03 | 1.44660E−02 | −1.24920E−02 | 6.89970E−03 |
| R4 | −4.99135E+00 | 7.89040E−03 | −4.02910E−03 | 7.93170E−03 | −1.22870E−02 | 1.22610E−02 |
| R5 | 7.23501E−01 | 1.57570E−02 | 7.38550E−03 | −2.16990E−02 | 2.33660E−02 | −1.36920E−02 |
| R6 | −1.66414E+01 | −5.45960E−02 | 9.60690E−02 | −1.62270E−01 | 1.81100E−01 | −1.29750E−01 |
| R9 | −2.84215E+01 | −3.02430E−02 | 1.01730E−01 | −2.05450E−01 | 2.62960E−01 | −2.14730E−01 |
| R10 | −1.10303E+01 | −9.34200E−02 | 1.94330E−01 | −2.45610E−01 | 1.63550E−01 | −4.89630E−02 |
| R11 | −1.11294E−01 | −7.98060E−02 | 2.26500E−01 | −3.08420E−01 | 2.31810E−01 | −9.73850E−02 |
| R12 | 4.38682E+01 | −4.72340E−02 | 1.22730E−01 | −1.76300E−01 | 1.60970E−01 | −9.46690E−02 |

| | Cone | | | | |
|---|---|---|---|---|---|
| | Coefficient | Asphericity Coefficient | | | |
| | k | A14 | A16 | A18 | A20 |
| R3 | −2.41650E−03 | 5.16110E−04 | −6.07640E−05 | 2.99770E−06 | −2.41650E−03 |
| R4 | −7.26450E−03 | 2.48630E−03 | −4.53540E−04 | 3.41020E−05 | −7.26450E−03 |
| R5 | 4.35660E−03 | −6.34140E−04 | 5.82380E−06 | 5.72070E−06 | 4.35660E−03 |
| R6 | 5.92530E−02 | −1.66680E−02 | 2.63070E−03 | −1.78130E−04 | 5.92530E−02 |
| R9 | 1.10310E−01 | −3.43930E−02 | 5.93360E−03 | −4.33720E−04 | 1.10310E−01 |
| R10 | −3.06720E−03 | 6.65900E−03 | −1.78670E−03 | 1.60070E−04 | −3.06720E−03 |
| R11 | 2.01540E−02 | −5.80960E−04 | −4.81100E−04 | 5.83270E−05 | 2.01540E−02 |
| R12 | 3.58510E−02 | −8.42850E−03 | 1.11170E−03 | −6.21390E−05 | 3.58510E−02 |

Tables 7 and 8 show the design data for the reflection point and the stationary point of each lens in the camera optical lens 20 according to the second embodiment of the present application.

TABLE 7

| | Number of | Position of | Position of | Position of |
|---|---|---|---|---|
| | Inflection | Inflection | Inflection | Inflection |
| | Points | Point 1 | Point 2 | Point 3 |
| P2R1 | 3 | 1.485 | 2.035 | 2.165 |
| P2R2 | 1 | 1.265 | | |
| P3R1 | 1 | 1.785 | | |
| P5R1 | 3 | 1.105 | 1.585 | 1.675 |
| P5R2 | 1 | 1.785 | | |

TABLE 8

| | Number of Stationary Points | Position of Stationary Point 1 |
|---|---|---|
| P2R1 | 1 | 2.235 |
| P2R2 | 1 | 1.825 |
| P3R1 | 1 | 1.925 |
| P5R1 | 1 | 1.715 |

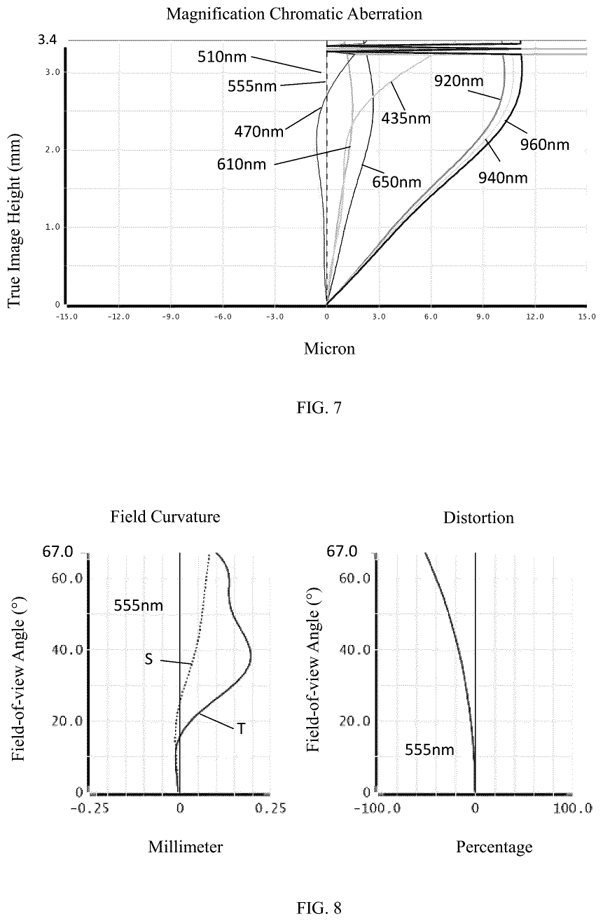

FIGS. 6 and 7 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 20 of the second embodiment. FIG. 8 is a schematic diagram showing the field curvature and distortion of light with a wavelength of 555 nm after passing through the camera optical lens 20 of the second embodiment. The field curvature S of FIG. 8 is a field curvature in the arc-sagittal direction, and T is a field curvature in the meridional direction.

As shown in Table 29, the second embodiment satisfies each of the relationship expressions.

In this embodiment, the camera optical lens 20 has an ENPD of 1.329 mm, a full field of view image height (IH) of 3.400 mm, and a field-of-view angle (FOV) of 150.850° in the diagonal direction. The camera optical lens 20 satisfies the design requirements of a large aperture and an ultra-wide angle and has excellent optical characteristics due to its on-axis and off-axis chromatic aberrations being sufficiently compensated.

### Third Embodiment

The third embodiment is basically the same as the first embodiment, the meaning of the symbols is the same as that of the first embodiment, and only the differences are listed below.

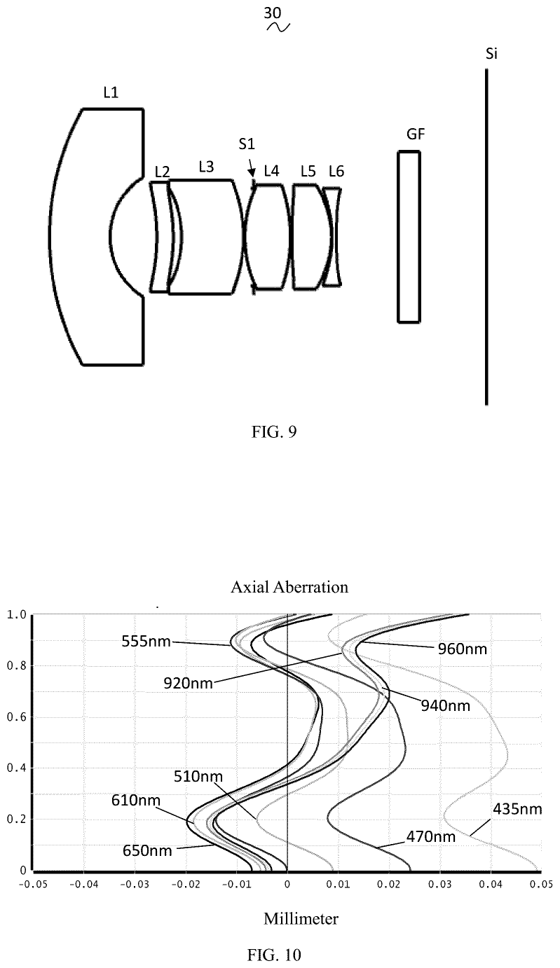

FIG. 9 shows a structural schematic diagram of the camera optical lens 30 of the third embodiment of the present application.

Tables 9 and 10 show the design data of the camera optical lens 30 of the third embodiment of the present application.

TABLE 9

| | R | d | | nd | | νd | |
|---|---|---|---|---|---|---|---|
| S1 | ∞ | d0= | −6.714 | | | | |
| R1 | 8.185 | d1= | 1.992 | nd1 | 1.8160 | ν1 | 46.56 |
| R2 | 2.203 | d2= | 1.538 | | | | |
| R3 | −6.097 | d3= | 0.541 | nd2 | 1.6613 | ν2 | 20.37 |
| R4 | −5.592 | d4= | 0.277 | | | | |
| R5 | −2.889 | d5= | 2.033 | nd3 | 1.5370 | ν3 | 55.98 |
| R6 | −4.216 | d6= | 0.051 | | | | |
| R7 | 3.798 | d7= | 1.487 | nd4 | 1.5111 | ν4 | 60.48 |
| R8 | −5.007 | d8= | 0.058 | | | | |
| R9 | 16.330 | d9= | 1.300 | nd5 | 1.5370 | ν5 | 55.98 |
| R10 | −2.455 | d10= | 0.017 | | | | |
| R11 | −3.837 | d11= | 0.145 | nd6 | 1.6613 | ν6 | 20.37 |
| R12 | 16.305 | d12= | 2.033 | | | | |
| R13 | ∞ | d13= | 0.700 | ndg | 1.5168 | νg | 64.17 |
| R14 | ∞ | d14= | 2.204 | | | | |

Table 10 illustrates aspherical data for each lens in the camera optical lens 30 according to the third embodiment of the present application.

TABLE 10

| | Cone Coefficient | Asphericity Coefficient | | | | |
|---|---|---|---|---|---|---|
| | k | A4 | A6 | A8 | A10 | A12 |
| R3 | −3.95135E+00 | 2.07360E−02 | −6.51180E−02 | 9.05670E−02 | −7.20450E−02 | 3.52940E−02 |
| R4 | −5.27930E+00 | −5.33200E−02 | 2.18970E−01 | −4.34800E−01 | 5.15610E−01 | −3.78230E−01 |
| R5 | 8.24230E−01 | 7.01790E−02 | −1.79660E−01 | 3.20230E−01 | −3.39860E−01 | 2.20420E−01 |
| R6 | −2.01416E+01 | −5.71090E−02 | 1.27310E−01 | −2.33210E−01 | 2.69580E−01 | −1.96190E−01 |
| R9 | −2.94481E+01 | −4.62050E−02 | 2.82750E−01 | −6.80610E−01 | 8.97740E−01 | −7.13990E−01 |
| R10 | −9.39694E+00 | −3.24410E−02 | 9.41370E−02 | −3.57300E−01 | 5.96630E−01 | −5.35980E−01 |
| R11 | −1.29305E+00 | −9.77750E−02 | 4.30110E−01 | −1.04560E+00 | 1.49130E+00 | −1.27910E+00 |
| R12 | 7.47110E+01 | −1.28170E−02 | 1.88010E−02 | 8.82950E−03 | −2.16860E−02 | 1.90020E−02 |

| | Cone Coefficient | Asphericity Coefficient | | | |
|---|---|---|---|---|---|
| | k | A14 | A16 | A18 | A20 |
| R3 | −3.95135E+00 | −1.07490E−02 | 1.98830E−03 | −2.05030E−04 | 9.06380E−06 |
| R4 | −5.27930E+00 | 1.72420E−01 | −4.73900E−02 | 7.17540E−03 | −4.58940E−04 |
| R5 | 8.24230E−01 | −8.84420E−02 | 2.13950E−02 | −2.85150E−03 | 1.60370E−04 |
| R6 | −2.01416E+01 | 9.00160E−02 | −2.52860E−02 | 3.97510E−03 | −2.68150E−04 |
| R9 | −2.94481E+01 | 3.51400E−01 | −1.05000E−01 | 1.74890E−02 | −1.24780E−03 |
| R10 | −9.39694E+00 | 2.81300E−01 | −8.68410E−02 | 1.46770E−02 | −1.05160E−03 |
| R11 | −1.29305E+00 | 6.69060E−01 | −2.09030E−01 | 3.58490E−02 | −2.59560E−03 |
| R12 | 7.47110E+01 | −1.24150E−02 | 5.58930E−03 | −1.38860E−03 | 1.38640E−04 |

Tables 11 and 12 show the design data for the reflection point and the stationary point of each lens in the camera optical lens 30 according to the third embodiment of the present application.

TABLE 11

| | Number of Inflection Points | Position of Inflection Point 1 |
|---|---|---|
| P2R1 | 1 | 1.375 |
| P2R2 | 1 | 1.235 |
| P5R1 | 1 | 1.105 |
| P6R1 | 1 | 1.515 |
| P6R2 | 1 | 1.545 |

TABLE 12

| | Number of Stationary Points | Position of Stationary Point 1 |
|---|---|---|
| P2R1 | 1 | 1.895 |
| P2R2 | 1 | 1.675 |
| P5R1 | 1 | 1.465 |

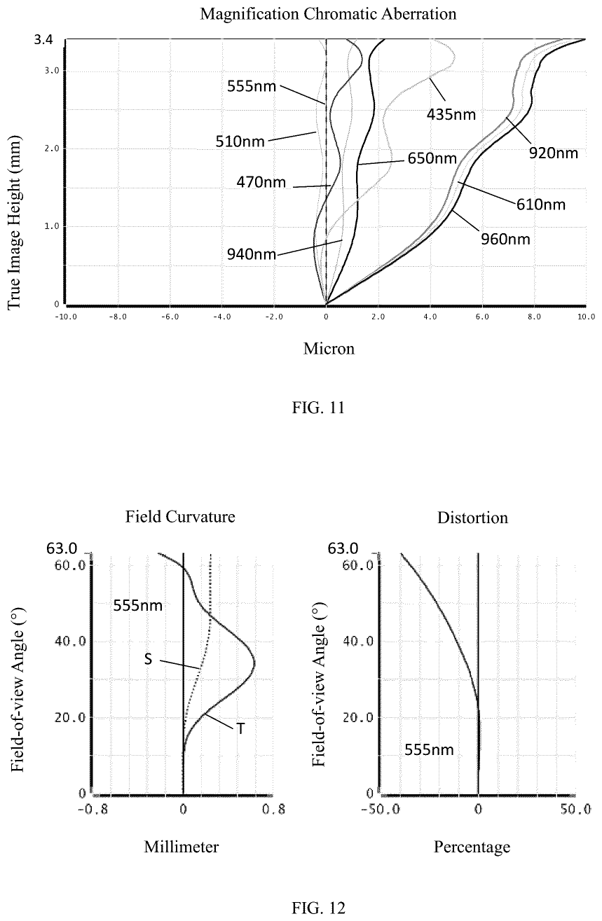

FIGS. 10 and 11 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 30 of the third embodiment. FIG. 12 is a schematic diagram showing the field curvature and distortion of light with a wavelength of 555 nm after passing through the camera optical lens 20 of the second embodiment. The field curvature S of FIG. 12 is a field curvature in the arc-sagittal direction, and T is the field curvature in the meridional direction.

As shown in Table 29, the third embodiment satisfies each of the relationship expressions.

In this embodiment, the camera optical lens 30 has an ENPD of 1.435 mm, a full field of view image height (IH) of 3.400 mm, and a field-of-view angle (FOV) of 126.08° in the diagonal direction. The camera optical lens 30 satisfies the design requirements of a large aperture and an ultra-wide angle and has excellent optical characteristics due to its on-axis and off-axis chromatic aberrations being sufficiently compensated.

### Fourth Embodiment

The fourth embodiment is basically the same as the first embodiment, the meaning of the symbols is the same as that of the first embodiment, and only the differences are listed below.

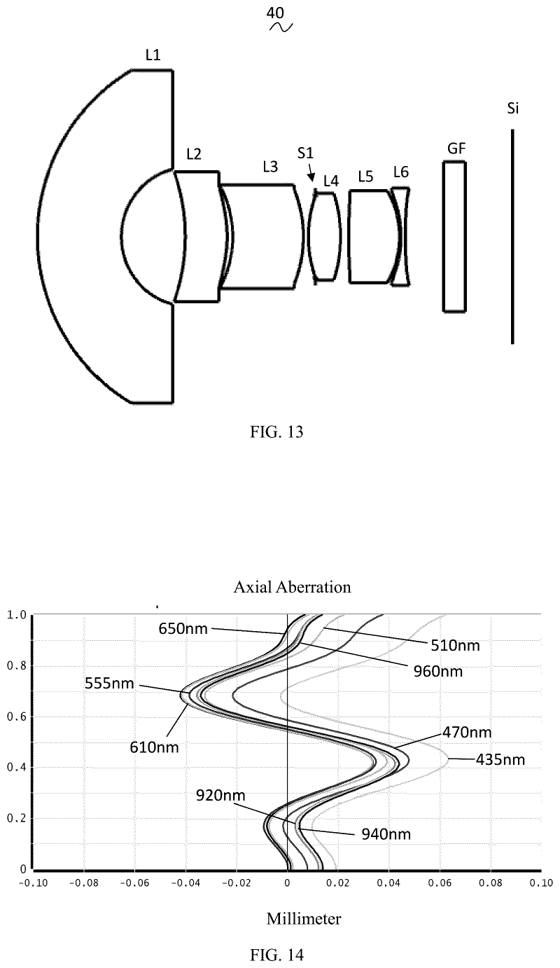

FIG. 13 shows a structural schematic diagram of the camera optical lens 40 of the fourth embodiment of the present application.

Tables 13 and 14 show design data of the camera optical lens 40 of the fourth embodiment of the present application.

TABLE 13

| | R | d | | nd | | νd | |
|---|---|---|---|---|---|---|---|
| S1 | ∞ | d0= | −9.124 | | | | |
| R1 | 6.195 | d1= | 2.754 | nd1 | 2.1042 | ν1 | 17.02 |
| R2 | 2.258 | d2= | 2.099 | | | | |
| R3 | −6.147 | d3= | 1.372 | nd2 | 1.6613 | ν2 | 20.37 |
| R4 | −3.993 | d4= | 0.190 | | | | |
| R5 | −3.103 | d5= | 2.316 | nd3 | 1.5370 | ν3 | 55.98 |
| R6 | −4.034 | d6= | 0.167 | | | | |
| R7 | 3.937 | d7= | 1.053 | nd4 | 1.4565 | ν4 | 90.27 |
| R8 | −4.500 | d8= | 0.268 | | | | |
| R9 | 14.919 | d9= | 1.674 | nd5 | 1.5370 | ν5 | 55.98 |
| R10 | −2.838 | d10= | 0.043 | | | | |
| R11 | −3.960 | d11= | 0.140 | nd6 | 1.6613 | ν6 | 20.37 |
| R12 | 14.300 | d12= | 1.262 | | | | |
| R13 | ∞ | d13= | 0.700 | ndg | 1.5168 | νg | 64.17 |
| R14 | ∞ | d14= | 1.569 | | | | |

Table 14 illustrates aspherical data for each lens in the camera optical lens 40 according to the fourth embodiment of the present application.

TABLE 14

| | Cone Coefficient | Asphericity Coefficient | | | | |
|---|---|---|---|---|---|---|
| | k | A4 | A6 | A8 | A10 | A12 |
| R3 | −3.13735E+00 | 1.87115E−02 | −5.02045E−02 | 6.38039E−02 | −4.86801E−02 | 2.31280E−02 |
| R4 | −3.82909E+00 | −4.06141E−03 | 4.17967E−02 | −6.87157E−02 | 5.97311E−02 | −2.83980E−02 |
| R5 | 7.99219E−01 | 1.54878E−02 | 1.44818E−03 | 6.64586E−03 | −2.39840E−02 | 2.79236E−02 |
| R6 | −1.54733E+01 | −6.43375E−02 | 1.23697E−01 | −2.12362E−01 | 2.55117E−01 | −2.04895E−01 |
| R9 | −8.48286E+01 | −2.82885E−02 | 2.60938E−02 | 1.15768E−01 | −3.34222E−01 | 3.87070E−01 |
| R10 | −7.42633E+00 | −3.30699E−02 | −9.08883E−02 | 3.51165E−01 | −5.62106E−01 | 4.94037E−01 |
| R11 | 5.25234E−01 | −8.75979E−02 | 2.55786E−01 | −4.24146E−01 | 4.16492E−01 | −2.51557E−01 |
| R12 | 4.63788E+01 | −1.07617E−02 | 4.41517E−02 | −1.02018E−01 | 1.33302E−01 | −1.00378E−01 |

| | Cone Coefficient | Asphericity Coefficient | | | |
|---|---|---|---|---|---|
| | k | A14 | A16 | A18 | A20 |
| R3 | −3.13735E+00 | −6.88108E−03 | 1.24586E−03 | −1.25379E−04 | 5.37156E−06 |
| R4 | −3.82909E+00 | 6.40335E−03 | −9.29813E−05 | −2.19506E−04 | 2.78987E−05 |
| R5 | 7.99219E−01 | −1.70345E−02 | 5.82817E−03 | −1.05503E−03 | 7.85541E−05 |
| R6 | −1.54733E+01 | 1.06202E−01 | −3.37932E−02 | 5.97623E−03 | −4.48776E−04 |
| R9 | −8.48286E+01 | −2.43313E−01 | 8.67148E−02 | −1.64610E−02 | 1.29266E−03 |
| R10 | −7.42633E+00 | −2.55943E−01 | 7.80727E−02 | −1.29894E−02 | 9.10060E−04 |
| R11 | 5.25234E−01 | 9.49586E−02 | −2.18163E−02 | 2.77796E−03 | −1.48642E−04 |
| R12 | 4.63788E+01 | 4.53706E−02 | −1.21601E−02 | 1.77418E−03 | −1.07924E−04 |

Tables 15 and 16 show the design data for the reflection point and the stationary point of each lens in the camera optical lens 40 according to the fourth embodiment of the present application.

TABLE 15

| | Number of Inflection Points | Position of Inflection Point 1 |
|---|---|---|
| P2R1 | 1 | 2.165 |
| P2R2 | 1 | 1.425 |
| P3R1 | 1 | 1.785 |
| P5R1 | 1 | 0.875 |
| P5R2 | 1 | 1.695 |
| P6R1 | 1 | 1.435 |

TABLE 16

| | Number of Stationary Points | Position of Stationary Point 1 |
|---|---|---|
| P2R1 | 1 | 2.275 |
| P5R1 | 1 | 1.335 |
| P5R2 | 1 | 1.785 |
| P6R1 | 1 | 1.745 |

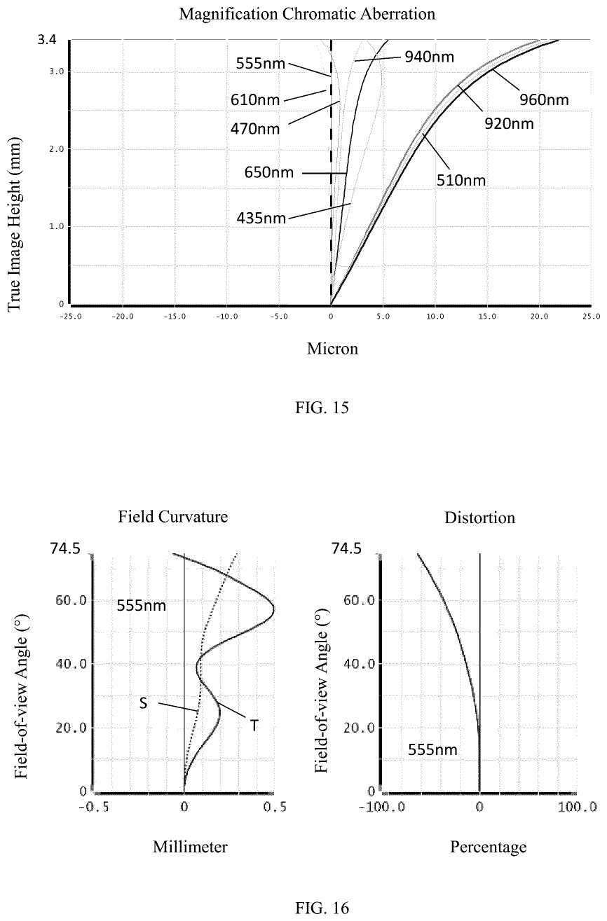

FIGS. 14 and 15 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 40 of the fourth embodiment. FIG. 16 is a schematic diagram showing the field curvature and distortion of light with a wavelength of 555 nm after passing through the camera optical lens 40 of the fourth embodiment. The field curvature S of FIG. 16 is a field curvature in the arc-sagittal direction, and T is a field curvature in the meridional direction.

As shown in Table 29, the fourth embodiment satisfies each of the relationship expressions.

In this embodiment, the camera optical lens 40 has an ENPD of 1.297 mm, a full field of view image height (IH) of 3.400 mm, and a field-of-view angle (FOV) of 149.20° in the diagonal direction. The camera optical lens 30 satisfies the design requirements of a large aperture and an ultra-wide angle and has excellent optical characteristics due to its on-axis and off-axis chromatic aberrations being sufficiently compensated.

### Fifth Embodiment

The fifth embodiment is basically the same as the first embodiment, the meaning of the symbols is the same as that of the first embodiment, and only the differences are listed below.

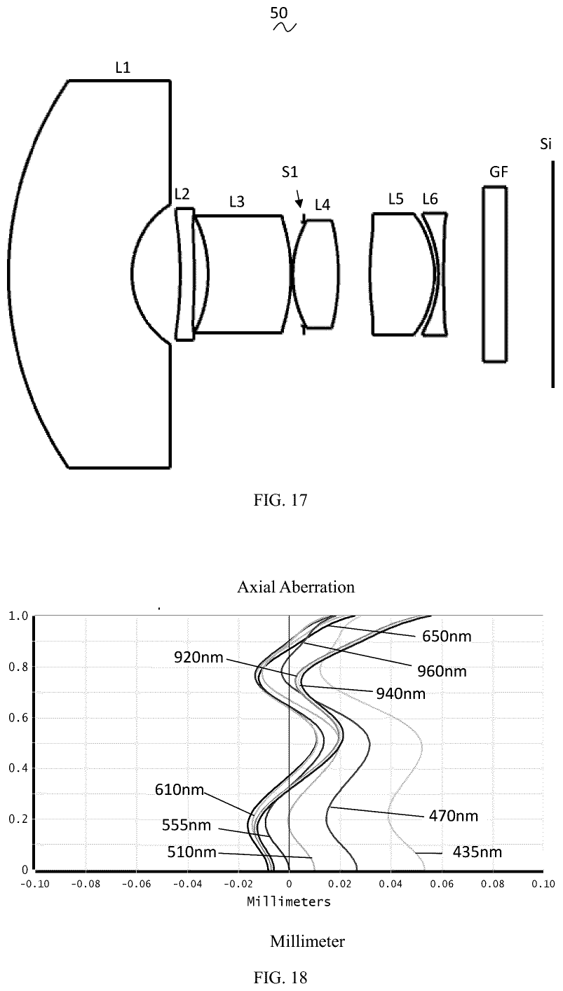

FIG. 17 shows a structural schematic diagram of the camera optical lens 50 of the fifth embodiment of the present application.

Tables 17 and 18 show design data of the camera optical lens 50 of the fifth embodiment of the present application.

TABLE 17

| | R | d | | nd | | ν d | |
|---|---|---|---|---|---|---|---|
| S1 | ∞ | d0= | −9.070 | | | | |
| R1 | 10.184 | d1= | 3.797 | nd1 | 1.8160 | ν 1 | 46.56 |
| R2 | 2.499 | d2= | 1.483 | | | | |
| R3 | −13.017 | d3= | 0.429 | nd2 | 1.6613 | ν 2 | 20.37 |
| R4 | −15.247 | d4= | 0.424 | | | | |
| R5 | −3.763 | d5= | 2.553 | nd3 | 1.5370 | ν 3 | 55.98 |
| R6 | −4.799 | d6= | 0.050 | | | | |
| R7 | 3.250 | d7= | 1.400 | nd4 | 1.4565 | ν 4 | 90.27 |
| R8 | −6.394 | d8= | 0.968 | | | | |
| R9 | 8.163 | d9= | 1.991 | nd5 | 1.5370 | ν 5 | 55.98 |
| R10 | −1.890 | d10= | 0.115 | | | | |
| R11 | −3.300 | d11= | 0.150 | nd6 | 1.6613 | ν 6 | 20.37 |
| R12 | 5.947 | d12= | 1.231 | | | | |
| R13 | ∞ | d13= | 0.700 | ndg | 1.5168 | ν g | 64.17 |
| R14 | ∞ | d14= | 1.439 | | | | |

Table 18 illustrates aspherical data for each lens in the camera optical lens 50 according to the fifth embodiment of the present application.

TABLE 18

| | Cone Coefficient | Asphericity Coefficient | | | | |
|---|---|---|---|---|---|---|
| | k | A4 | A6 | A8 | A10 | A12 |
| R3 | 2.26730E+00 | −4.77740E−03 | −3.52190E−03 | 6.56930E−03 | −4.01050E−03 | 8.39660E−04 |
| R4 | −3.55182E+00 | 3.79610E−02 | −1.14670E−01 | 2.05110E−01 | −2.18330E−01 | 1.44570E−01 |
| R5 | 1.25235E+00 | 3.50420E−02 | −8.60510E−02 | 1.61060E−01 | −1.92620E−01 | 1.46070E−01 |
| R6 | −2.42438E+01 | −2.84990E−02 | 1.89460E−02 | −3.93470E−03 | −1.61050E−02 | 2.29110E−02 |
| R9 | −3.73321E+01 | −1.99860E−02 | 1.07200E−01 | −2.44570E−01 | 3.24850E−01 | −2.68600E−01 |
| R10 | −1.36350E+01 | −4.87050E−02 | 2.46920E−02 | 4.22020E−02 | −1.01920E−01 | 9.23870E−02 |
| R11 | −3.07906E−01 | −4.76140E−02 | 1.63880E−01 | −2.51060E−01 | 2.16860E−01 | −1.13620E−01 |
| R12 | −5.80560E+02 | −1.64780E−02 | 1.30220E−02 | −1.36450E−02 | 1.03100E−02 | −2.54740E−03 |

| | Cone Coefficient | Asphericity Coefficient | | | |
|---|---|---|---|---|---|
| | k | A14 | A16 | A18 | A20 |
| R3 | 2.26730E+00 | 2.97380E−04 | −2.04300E−04 | 4.20130E−05 | −3.05160E−06 |
| R4 | −3.55182E+00 | −5.98390E−02 | 1.50370E−02 | −2.09460E−03 | 1.23850E−04 |
| R5 | 1.25235E+00 | −6.96710E−02 | 2.01900E−02 | −3.23910E−03 | 2.20200E−04 |
| R6 | −2.42438E+01 | −1.43580E−02 | 4.77310E−03 | −8.12780E−04 | 5.53500E−05 |
| R9 | −3.73321E+01 | 1.38950E−01 | −4.37180E−02 | 7.64160E−03 | −5.68680E−04 |
| R10 | −1.36350E+01 | −4.60560E−02 | 1.32440E−02 | −2.05940E−03 | 1.34190E−04 |
| R11 | −3.07906E−01 | 3.63070E−02 | −6.71790E−03 | 6.23980E−04 | −1.89680E−05 |
| R12 | −5.80560E+02 | −9.07070E−04 | 7.27150E−04 | −1.71040E−04 | 1.43340E−05 |

Tables 19 and 20 show the design data for the reflection point and the stationary point of each lens in the camera optical lens 50 according to the fifth embodiment of the present application.

TABLE 19

| | Number of Inflection | Position of | Position of |
|---|---|---|---|
| | Points | Inflection Point 1 | Inflection Point 2 |
| P2R1 | 2 | 1.455 | 1.975 |
| P2R2 | 1 | 1.035 | |
| P3R1 | 1 | 1.755 | |
| P5R1 | 1 | 1.085 | |
| P5R2 | 1 | 1.805 | |
| P6R1 | 1 | 1.565 | |
| P6R2 | 2 | 0.405 | 1.045 |

TABLE 20

| | Number of Stationary Points | Position of Stationary Point 1 |
|---|---|---|
| P2R2 | 1 | 1.475 |
| P5R1 | 1 | 1.485 |
| P5R2 | 1 | 1.915 |
| P6R1 | 1 | 1.855 |

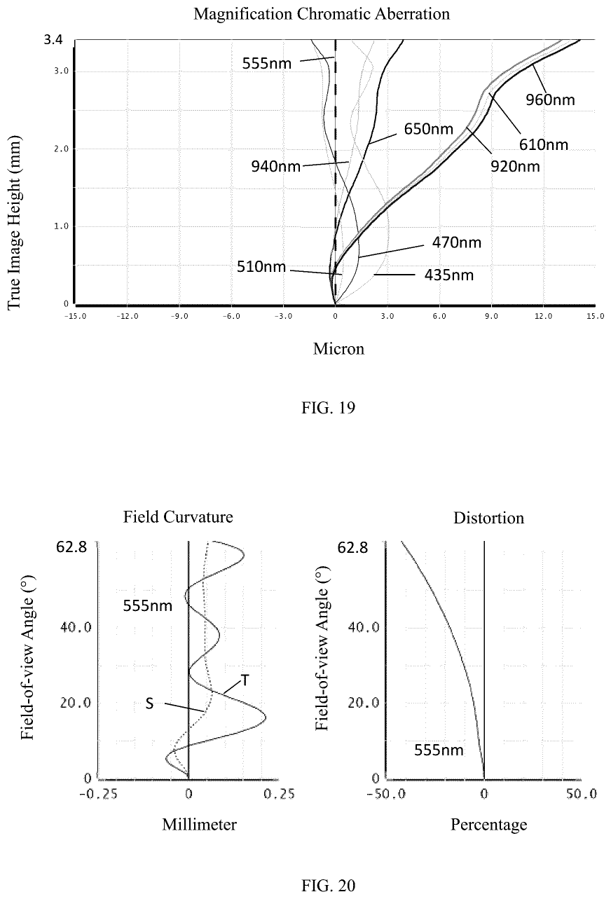

FIGS. 18 and 19 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 50 of the fifth embodiment. FIG. 20 is a schematic diagram showing the field curvature and distortion of light with a wavelength of 555 nm after passing through the camera optical lens 50 of the fifth embodiment. The field curvature S of FIG. 20 is a field curvature in the arc-sagittal direction, and T is a field curvature in the meridional direction.

As shown in Table 29, the fifth embodiment satisfies each of the relationship expressions.

In this embodiment, the camera optical lens 50 has an ENPD of 1.516 mm, a full field of view image height (IH) of 3.400 mm, and a field-of-view angle (FOV) of 125.52° in the diagonal direction. The camera optical lens 30 satisfies the design requirements of a large aperture and an ultra-wide angle and has excellent optical characteristics due to its on-axis and off-axis chromatic aberrations being sufficiently compensated.

### Sixth Embodiment

The sixth embodiment is basically the same as the first embodiment, the meaning of the symbols is the same as that of the first embodiment, and only the differences are listed below.

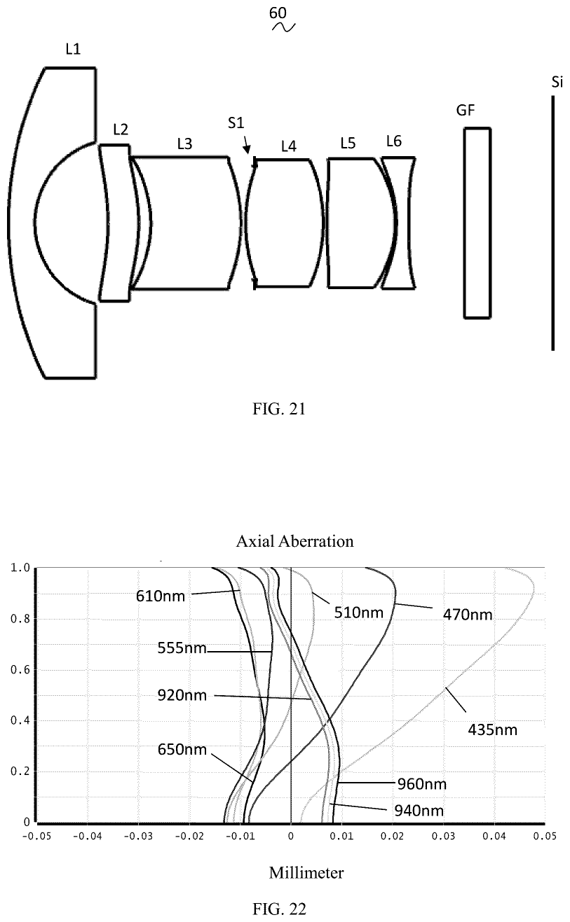

FIG. 21 shows a structural schematic diagram of the camera optical lens 60 of the sixth embodiment of the present application.

Tables 21 and 22 show the design data of the camera optical lens 60 of the sixth embodiment of the present application.

TABLE 21

| | R | d | | nd | | νd | |
|---|---|---|---|---|---|---|---|
| S1 | ∞ | d0= | −6.687 | | | | |
| R1 | 9.263 | d1= | 0.719 | nd1 | 1.8160 | ν1 | 46.56 |
| R2 | 2.256 | d2= | 1.982 | | | | |
| R3 | −6.339 | d3= | 0.834 | nd2 | 1.6613 | ν2 | 20.37 |
| R4 | −4.552 | d4= | 0.332 | | | | |
| R5 | −2.980 | d5= | 2.445 | nd3 | 1.5370 | ν3 | 55.98 |
| R6 | −3.846 | d6= | 0.130 | | | | |
| R7 | 4.403 | d7= | 2.108 | nd4 | 1.4565 | ν4 | 90.27 |
| R8 | −4.040 | d8= | 0.098 | | | | |
| R9 | 15.592 | d9= | 1.853 | nd5 | 1.5370 | ν5 | 55.98 |
| R10 | −2.889 | d10= | 0.030 | | | | |
| R11 | −3.802 | d11= | 0.335 | nd6 | 1.6613 | ν6 | 20.37 |
| R12 | 17.642 | d12= | 1.510 | | | | |
| R13 | ∞ | d13= | 0.700 | ndg | 1.5168 | νg | 64.17 |
| R14 | ∞ | d14= | 1.711 | | | | |

Table 22 illustrates aspherical data for each lens in the camera optical lens 60 according to the sixth embodiment of the present application.

TABLE 22

| | Cone Coefficient | Asphericity Coefficient | | | | |
|---|---|---|---|---|---|---|
| | k | A4 | A6 | A8 | A10 | A12 |
| R3 | −5.26333E+00 | 1.53770E−03 | 1.27940E−03 | −1.37770E−03 | 1.20340E−03 | −6.42960E−04 |
| R4 | −4.71273E+00 | 7.96950E−03 | −2.35540E−03 | 2.72850E−03 | −3.66380E−03 | 3.46090E−03 |
| R5 | 6.68006E−01 | 1.65310E−02 | −6.01510E−03 | 3.98110E−03 | −1.73090E−03 | 3.01070E−04 |
| R6 | −1.82930E+01 | −3.41340E−02 | 1.96530E−02 | −1.09100E−02 | 4.89380E−03 | −1.47880E−03 |
| R9 | −3.74611E+01 | 2.60190E−03 | −3.72980E−03 | 5.65100E−03 | −9.43890E−03 | 8.73760E−03 |
| R10 | −7.98432E+00 | −8.11840E−02 | 1.18600E−01 | −1.56910E−01 | 1.38180E−01 | −7.96560E−02 |
| R11 | −1.91115E−01 | −5.36410E−02 | 1.09310E−01 | −1.43440E−01 | 1.25650E−01 | −7.19320E−02 |
| R12 | 7.15775E+01 | −9.95820E−03 | 1.71010E−02 | −9.72040E−03 | 3.22040E−03 | 2.52390E−04 |

| | Cone Coefficient | Asphericity Coefficient | | | |
|---|---|---|---|---|---|
| | k | A14 | A16 | A18 | A20 |
| R3 | −5.26333E+00 | 2.19890E−04 | −4.62450E−05 | 5.41300E−06 | −2.67910E−07 |
| R4 | −4.71273E+00 | −1.96630E−03 | 6.55880E−04 | −1.18750E−04 | 9.03040E−06 |
| R5 | 6.68006E−01 | 1.45550E−04 | −9.76290E−05 | 2.16060E−05 | −1.68540E−06 |
| R6 | −1.82930E+01 | 2.31420E−04 | 6.34770E−06 | −8.37830E−06 | 9.19550E−07 |
| R9 | −3.74611E+01 | −4.89780E−03 | 1.62510E−03 | −2.94130E−04 | 2.24150E−05 |
| R10 | −7.98432E+00 | 2.98100E−02 | −6.98660E−03 | 9.32180E−04 | −5.40500E−05 |
| R11 | −1.91115E−01 | 2.67120E−02 | −6.20590E−03 | 8.20150E−04 | −4.70810E−05 |
| R12 | 7.15775E+01 | −7.51700E−04 | 3.11430E−04 | −5.75640E−05 | 4.15060E−06 |

Tables 23 and 24 show the design data for the reflection point and the stationary point of each lens in the camera optical lens 60 according to the sixth embodiment of the present application.

TABLE 23

| | Number of Inflection | Position of | Position of |
|---|---|---|---|
| | Points | Inflection Point 1 | Inflection Point 2 |
| P2R1 | 1 | 1.465 | |
| P2R2 | 1 | 1.345 | |
| P3R1 | 1 | 1.825 | |
| P5R1 | 2 | 1.035 | 1.785 |
| P6R1 | 1 | 1.505 | |

TABLE 24

| | Number of Stationary Points | Position of Stationary Point 1 |
|---|---|---|
| P2R2 | 1 | 1.855 |
| P5R1 | 1 | 1.445 |

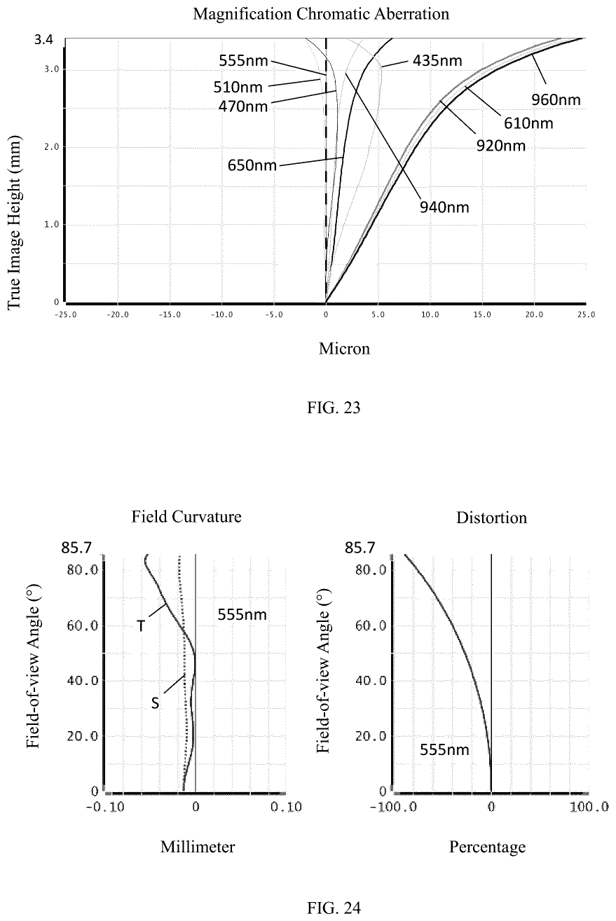

FIGS. 22 and 23 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 60 of the sixth embodiment. FIG. 24 is a schematic diagram showing the field curvature and distortion of light with a wavelength of 555 nm after passing through the camera optical lens 60 of the sixth embodiment. The field curvature S of FIG. 24 is a field curvature in the arc-sagittal direction, and T is a field curvature in the meridional direction.

As shown in Table 29, the sixth embodiment satisfies each of the relationship expressions.

In this embodiment, the camera optical lens 60 has an ENPD of 1.138 mm, a full field of view image height (IH) of 3.400 mm, and a field-of-view angle (FOV) of 171.38° in the diagonal direction. The camera optical lens 30 satisfies the design requirements of a large aperture and an ultra-wide angle and has excellent optical characteristics due to its on-axis and off-axis chromatic aberrations being sufficiently compensated.

### Comparison Embodiment

The meaning of the symbols of the Comparison embodiment is the same as that of the first embodiment, and only the differences are listed below.

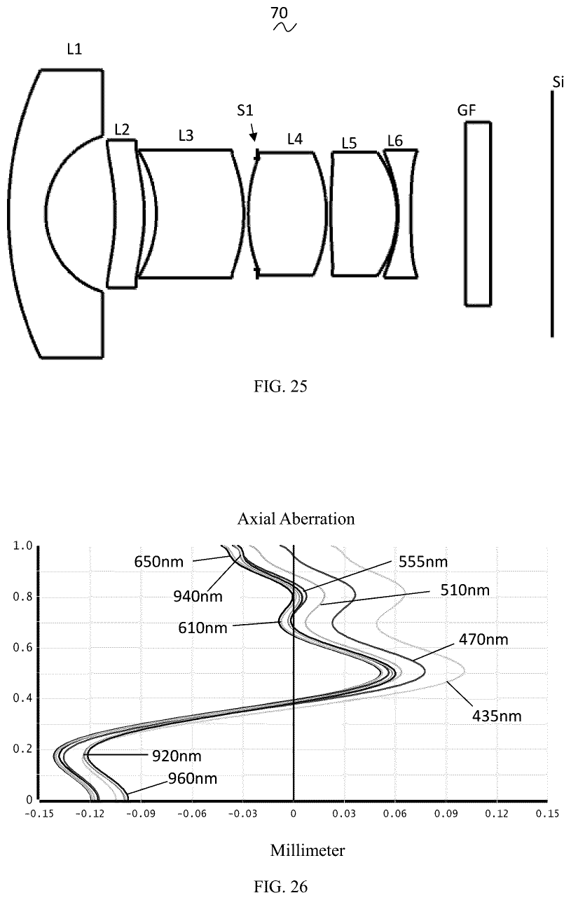

FIG. 25 shows a structural schematic diagram of the camera optical lens 70 of the comparison embodiment.

Tables 25 and 26 show the design data of the camera optical lens 70 of the comparison embodiment.

TABLE 25

| | R | d | | nd | | νd | |
|---|---|---|---|---|---|---|---|
| S1 | ∞ | d0= | −6.998 | | | | |
| R1 | 9.164 | d1= | 1.053 | nd1 | 1.8160 | ν1 | 46.56 |
| R2 | 2.247 | d2= | 1.949 | | | | |
| R3 | −6.239 | d3= | 0.824 | nd2 | 1.6613 | ν2 | 20.37 |
| R4 | −4.558 | d4= | 0.341 | | | | |
| R5 | −2.982 | d5= | 2.455 | nd3 | 1.5370 | ν3 | 55.98 |
| R6 | −3.850 | d6= | 0.126 | | | | |
| R7 | 4.376 | d7= | 2.197 | nd4 | 1.4565 | ν4 | 90.27 |
| R8 | −4.054 | d8= | 0.127 | | | | |
| R9 | 15.516 | d9= | 1.864 | nd5 | 1.5370 | ν5 | 55.98 |
| R10 | −2.875 | d10= | 0.030 | | | | |
| R11 | −3.797 | d11= | 0.357 | nd6 | 1.6613 | ν6 | 20.37 |
| R12 | 17.479 | d12= | 1.539 | | | | |
| R13 | ∞ | d13= | 0.700 | ndg | 1.5168 | νg | 64.17 |
| R14 | ∞ | d14= | 1.742 | | | | |

Table 26 illustrates aspherical data for each lens in the camera optical lens 70 of the comparison embodiment.

TABLE 26

| | Cone Coefficient | Asphericity Coefficient | | | | |
|---|---|---|---|---|---|---|
| | k | A4 | A6 | A8 | A10 | A12 |
| R3 | −4.95967E+00 | −3.48400E−03 | 1.81620E−02 | −3.11130E−02 | 3.04710E−02 | −1.77650E−02 |
| R4 | −4.78110E+00 | 9.92220E−03 | 5.09430E−03 | −2.27970E−02 | 2.92070E−02 | −1.96970E−02 |
| R5 | 6.65013E−01 | 1.49190E−02 | −8.75290E−03 | 4.19970E−03 | 1.20130E−02 | −1.96410E−02 |
| R6 | −1.84568E+01 | −3.64980E−02 | 1.76590E−02 | 3.27470E−02 | −9.93280E−02 | 1.13950E−01 |
| R9 | −3.90813E+01 | 2.20570E−02 | −1.31240E−01 | 3.42980E−01 | −4.86820E−01 | 4.07600E−01 |
| R10 | −8.01358E+00 | −7.80720E−02 | 1.06710E−01 | −1.31140E−01 | 1.06260E−01 | −5.68790E−02 |
| R11 | −1.73530E−01 | −5.72530E−02 | 1.16960E−01 | −1.43860E−01 | 1.09760E−01 | −4.97480E−02 |
| R12 | 7.15553E+01 | −5.66250E−03 | 1.50900E−02 | −2.26280E−02 | 2.38090E−02 | −1.35390E−02 |

| | Cone Coefficient | Asphericity Coefficient | | | |
|---|---|---|---|---|---|
| | k | A14 | A16 | A18 | A20 |
| R3 | −4.95967E+00 | 6.31230E−03 | −1.33860E−03 | 1.55580E−04 | −7.61890E−06 |
| R4 | −4.78110E+00 | 7.72060E−03 | −1.74180E−03 | 2.05790E−04 | −9.48740E−06 |
| R5 | 6.65013E−01 | 1.27790E−02 | −4.28630E−03 | 7.34380E−04 | −5.09710E−05 |
| R6 | −1.84568E+01 | −7.07910E−02 | 2.50750E−02 | −4.77330E−03 | 3.79700E−04 |
| R9 | −3.90813E+01 | −2.08000E−01 | 6.35940E−02 | −1.07080E−02 | 7.63560E−04 |
| R10 | −8.01358E+00 | 2.02890E−02 | −4.69840E−03 | 6.43330E−04 | −3.95930E−05 |
| R11 | −1.73530E−01 | 1.23720E−02 | −1.20130E−03 | −9.15180E−05 | 2.10380E−05 |
| R12 | 7.15553E+01 | 4.19770E−03 | −6.77290E−04 | 4.54810E−05 | −1.73750E−07 |

Tables 27 and 28 show the design data for the reflection point and the stationary point of each lens in the camera optical lens 70 of the comparison embodiment.

TABLE 27

| | Number of Inflection Points | Position of Inflection Point 1 |
|---|---|---|
| P2R1 | 1 | 1.465 |
| P2R2 | 1 | 1.325 |
| P3R2 | 1 | 1.625 |
| P5R1 | 1 | 0.985 |
| P6R1 | 1 | 1.485 |

TABLE 28

| | Number of Stationary Points | Position of Stationary Point 1 |
|---|---|---|
| P5R1 | 1 | 1.445 |

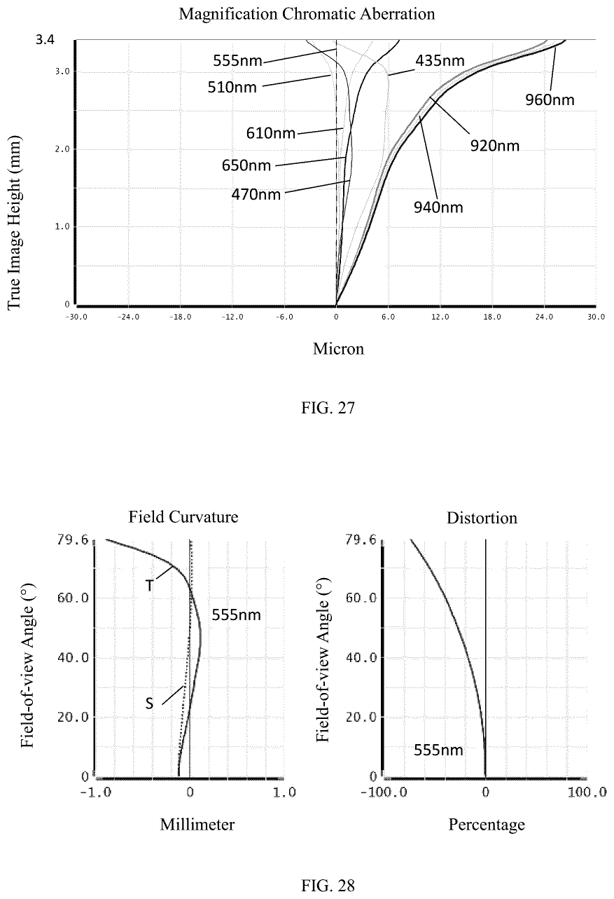

FIGS. 26 and 27 are schematic diagrams showing the axial aberration and the magnification chromatic aberration of light with wavelengths of 960 nm, 940 nm, 920 nm, 650 nm, 610 nm, 555 nm, 510 nm, 470 nm, and 435 nm, respectively, after passing through the camera optical lens 70 of the contrasting embodiment. FIG. 28 is a schematic diagram showing the field curvature and distortion of light with a wavelength of 555 nm passing through the camera optical lens 70 of the comparison embodiment. The field curvature S of FIG. 28 is a field curvature in the arc-vector direction, and T is a field curvature in the meridian direction.

Table 29 below lists the values corresponding to each of the relationship expressions in the comparison embodiment in accordance with the above relationship expressions. Obviously, the camera optical lens 70 of the comparison embodiment does not satisfy the above relationship expression: 5.00≤TTL/f≤6.50.

In the comparison embodiment, the camera optical lens 70 has an ENPD of 1.164 mm, a full-field-of-view image height (IH) of 3.400 mm, and a field-of-view angle (FOV) of 160.81° in the diagonal direction. The camera optical lens 70 does not satisfy the design requirements of a large aperture and an ultra-wide angle.

TABLE 29

| Parameters | | | | | | | |
|---|---|---|---|---|---|---|---|
| and | | | | | | | |
| relationship | First | Second | Third | Fourth | Fifth | Sixth | Comparison |
| expressions | Embodiment | Embodiment | Embodiment | Embodiment | Embodiment | Embodiment | Embodiment |
| n1 | 1.816 | 1.702 | 1.816 | 2.104 | 1.816 | 1.816 | 1.816 |
| TTL/f | 6.325 | 5.091 | 5.010 | 6.015 | 5.517 | 6.499 | 6.571 |
| R12/R11 | −4.608 | −6.649 | −4.249 | −3.611 | −1.802 | −4.640 | −4.603 |
| v4 | 90.274 | 90.274 | 60.479 | 90.274 | 90.274 | 90.274 | 90.274 |
| d5/d3 | 2.967 | 4.778 | 3.754 | 1.688 | 5.955 | 2.932 | 2.979 |
| f5/f | 2.021 | 1.815 | 1.415 | 1.764 | 1.009 | 2.061 | 2.004 |
| BF/TTL | 0.268 | 0.290 | 0.343 | 0.226 | 0.201 | 0.265 | 0.260 |
| f | 2.326 | 2.657 | 2.869 | 2.595 | 3.033 | 2.275 | 2.329 |
| f1 | −3.859 | −4.406 | −4.328 | −5.048 | −5.199 | −3.816 | −3.902 |
| f2 | 19.942 | 19.360 | 70.850 | 13.615 | −144.555 | 20.395 | 21.206 |
| f3 | −1275.777 | −274.695 | −36.726 | −193.340 | −236.950 | −2256.847 | −2578.253 |
| f4 | 5.000 | 4.928 | 4.469 | 4.777 | 4.936 | 4.997 | 5.011 |
| f5 | 4.702 | 4.823 | 4.060 | 4.577 | 3.061 | 4.689 | 4.668 |
| f6 | −4.650 | −4.662 | −4.643 | −4.635 | −3.161 | −4.660 | −4.646 |
| f12 | −6.001 | −6.953 | −4.889 | −11.890 | −5.053 | −5.881 | −5.901 |
| FNO | 2.000 | 1.999 | 1.999 | 2.000 | 2.000 | 1.999 | 2.000 |
| TTL | 14.712 | 13.530 | 14.376 | 15.607 | 16.730 | 14.787 | 15.304 |
| IH | 3.400 | 3.400 | 3.400 | 3.400 | 3.400 | 3.400 | 3.400 |
| FOV | 165.96 | 150.85 | 126.08 | 149.20 | 125.52 | 171.38 | 160.81 |

It can be understood by those of ordinary skill in the art that each of the above embodiments is a specific embodiment for realizing the present application, and that various changes can be made thereto in form and detail in practical application without departing from the spirit and scope of the present application.

What is claimed is:

1. A camera optical lens, comprises in order from an objective side to an image side:
a first lens having a negative refractive force;
a second lens having a refractive force;
a third lens having a negative refractive force;
a fourth lens having a positive refractive force;
a fifth lens having a positive refractive force; and
a sixth lens having a negative refractive force;
wherein a refractive index of the first lens is n1; a focal length of the camera optical lens is f, an optical total length of the camera optical lens is TTL; a central radius of curvature of an objective surface of the sixth lens of R11; a central radius of curvature of an image surface of the sixth lens of R12, and the following relationship expressions are satisfied:
$$n 1 \geq 1.7 ;$$
$$5. \leq TTL / f \leq 6 \text{.50} ;$$
$$- 6.7 \leq R 12 / R 11 \leq - 1.8 .$$

2. The camera optical lens of claim 1, wherein an Abbe number of the fourth lens is v4, and the following relationship expression is satisfied:
60.00≤v4≤91.00.

3. The camera optical lens of claim 1, wherein an on-axis thickness of the second lens is d3; an on-axis thickness of the third lens is d5, and the following relationship expression is satisfied:
$$1. 68 \leq d 5 / d 3 \leq 6.00 .$$

4. The camera optical lens of claim 1, wherein a focal length of the fifth lens is f5, and the following relationship expression is satisfied:
$$1. 00 \leq f 5 / f \leq 2.10 .$$

5. The camera optical lens of claim 1, wherein an on-axis distance from an image surface to an image surface of the sixth lens is BF, and the following relationship expression is satisfied:
$$0.2 \leq BF / TTL \leq 0.35 .$$

6. The camera optical lens of claim 1, wherein an objective surface of the first lens is convex at a proximal-axis position, and an image surface of the first lens is concave at a proximal-axis position;
a focal length of the first lens is f1; a central radius of curvature of the objective surface of the first lens is R1; a central radius of curvature of the image surface of the first lens is R2; an on-axis thickness of the first lens is d1, and the following relationship expressions are satisfied:
$$- 3.89 \leq f 1 / f \leq - 1.01 ;$$
$$0.82 \leq ( R 1 + R 2 ) / ( R 1 - R 2 ) \leq 3.22 ;$$
$$0.02 \leq d 1 / TTL \leq 0.34 .$$

7. The camera optical lens of claim 1, wherein an objective surface of the second lens is concave at a proximal-axis position, and an image surface of the second lens is convex at a proximal-axis position;
a focal length of the second lens is f2; a central radius of curvature of the objective surface of the second lens is R3; a central radius of curvature of the image surface of the second lens is R4; an on-axis thickness of the second lens is d3, and the following relationship expressions are satisfied:
$$- 95.3 \leq f 2 / f \leq 37 \text{.04} ;$$
$$- 25.35 \leq ( R 3 + R 4 ) / ( R 3 - R 4 ) \leq 34 \text{.72} ;$$
$$0.01 \leq d 3 / TTL \leq 0.13 .$$

8. The camera optical lens of claim 1, wherein an objective surface of the third lens is concave at a proximal-axis position, and an image surface of the third lens is convex at a proximal-axis position;
a focal length of the third lens is f3; a central radius of curvature of the objective surface of the third lens is R5; a central radius of curvature of the image surface of the third lens is R6; an on-axis thickness of the third lens is d5, and the following relationship expressions are satisfied:
$$- 198 \; 0 \leq f 3 / f \leq - 8 \text{.53} ;$$
$$- 16. 53 \leq ( R 5 + R 6 ) / ( R 5 - R 6 ) \leq - 3.57 ;$$
$$0.07 \leq d 5 / TTL \leq 0.28 .$$

9. The camera optical lens of claim 1, wherein an objective surface of the fourth lens is convex at a proximal-axis position; an image surface of the fourth lens is convex at a proximal-axis position;
a focal length of the fourth lens is f4; a central radius of curvature of the objective surface of the fourth lens is R7; a central radius of curvature of the image surface of the fourth lens is R8; an on-axis thickness of the fourth lens is d7, and the following relationship expressions are satisfied:
$$0.78 \leq f 4 / f \leq 3.29 ;$$
$$- 0.6 \; 5 \leq ( R 7 + R 8 ) / ( R 7 - R 8 ) \leq 0 \text{.06} ;$$
$$0.03 \leq d 7 / TTL \leq 0.22 .$$

10. The camera optical lens of claim 1, wherein the first lens is made of glass, and the fourth lens is made of glass.
